(19) United States
(12) Patent Application Publication
(10) Pub. No.: US 2009/0178572 A1
(43) Pub. Date: Jul. 16, 2009

(54) Material For a Manual Drip Coffee Cone

(76) Inventors: Justine Marie Wolcott, Watsonville, CA (US); William Mark Wolcott, Watsonville, CA (US)

Correspondence Address: JUSTINE M WOLCOTT, 408 KING ST, SANTA CRUZ, CA, 95060, US

(21) Appl. No.: 12/014,647

(22) Filed: Jan. 15, 2008

(51) Int. Cl. A47J 31/06

(52) U.S. Cl. 99/323

(57) ABSTRACT

One embodiment of a manual drip coffee cone of the type having a conical body 1, that is truncated at the bottom and fashioned in a round shape to hold a typical paper filter or other type of filter. The base of the conical body 1 forms a drip ring 2. The drip ring 2 directs drips into the receiving vessel and prevents the cone from slipping off the vessel. A round drip plate 3, is set inside the conical body 1 at a short height above the base of the cone. The drip plate 3 has a drip hole 4. A ring collar 5, radiates out from near the base of the cone so that it sits on a cup, carafe, or other vessel. The material of the embodiment includes, but is not limited to, metals such as steel, titanium, aluminum, iron, and others; enamel-coated metals; anodized metals; and other materials deemed desirable in the future for similar kitchen tools. Additional embodiments of the cone have a conical body with an elliptical shaped base 1′ that forms a corresponding drip ring with an elliptical shape 2′, and that further corresponds to a drip plate with an elliptical shape 3′; a ‘tea cup’ style handle 6, a measuring cup style handle 6′, or a tab style handle 6″ attached to the side of the cone; a drip hole with a mesh screen 4′; a ‘see-through’ ring collar frame comprised of an inner ring 7, an outer ring 8, and three radial spines 9 that connect the inner ring to the outer ring; or a conical body with double-wall construction 1″ that forms a corresponding drip ring with double-wall construction 2″.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND

1. Field of Invention

This invention relates generally to improvement of the design and material for a manual drip coffee cone.

2. Prior Art

A manual drip coffee cone is one of the most common coffee makers used today. Nearly every coffee drinker owns one. Manual drip coffee cones are designed to sit on top of a single coffee cup or carafe. Water is poured through a cone that holds a filter with coffee grounds, and the finished product of coffee drips into the cup below. An attractive feature of this simple method is that it takes very little clean-up effort, much less than what's required with an electric coffee maker, a stovetop percolator, or a French press. Also, a manual drip coffee cone gives a person more enjoyment of coffee's fine aromas because the steaming grounds are directly open to the air as it is brewing. Additionally, compared to other coffee-making apparatuses, a manual drip coffee cone is less expensive to buy.

Several manual drip coffee cones have been designed to date. Today, the cone that has been most widely produced and commercially successful is disclosed in a series of U.S. and foreign patents to Melitta-Werke Bentz & Sohn (Melitta/Bentz) dating from 1933 through 1970.

Problems with Prior Art Designs:

While the Melitta/Bentz cone designs have been the most successful, there is ample opportunity to simplify and improve them, and to improve other prior art as well. The most important aspect of prior art that needs improvement is to create a cone that can be easily fabricated using metal material such as stainless steel. Modern day manual drip coffee cones are designed to be made only in glass, ceramic, and plastic material. These are fabricated in a molding process wherein a mold creates a cone in one step. There are numerous reasons why stainless steel is a far superior material for a manual drip coffee cone. However, compared to a molding process, fabrication from sheet metal is more complicated because it requires multiple steps of welding components onto the main body of the cone. The problem to be solved is that making a metal cone from a design that works for a plastic mold is difficult and cost prohibitive. Therefore, a simpler design is needed in order to produce a metal cone that has the advantages of the popular molded designs.

Molded designs have detailed features that are difficult to reproduce in a metal fabrication process. Three aspects of prior art that need to change in order to manufacture a similar cone with metal material are as follows.

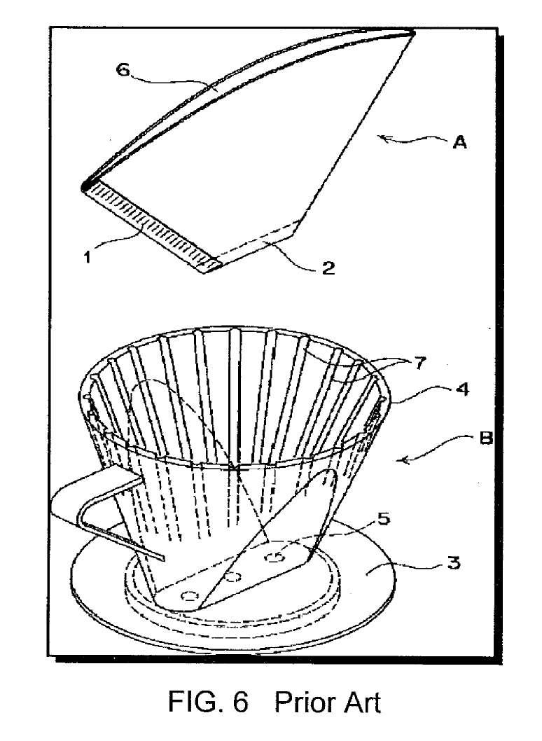

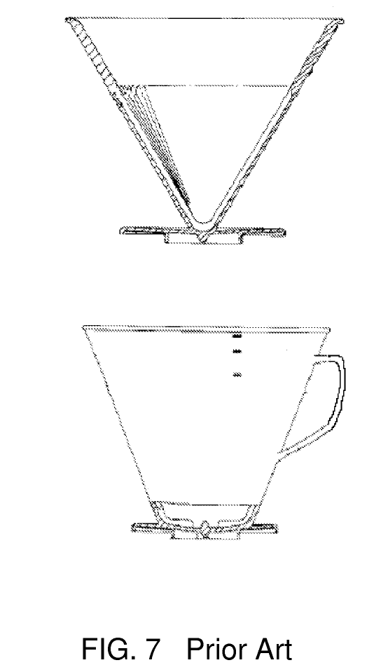

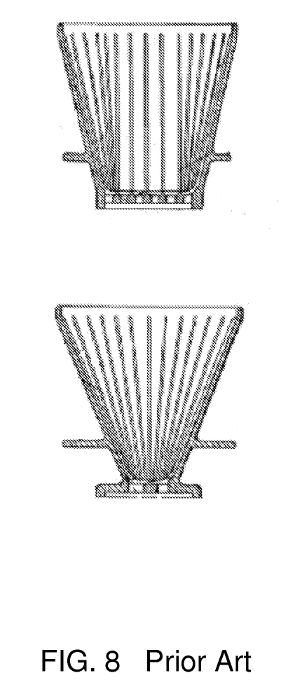

(1) The drip ring should be the same width as the base of the cone. If the drip ring is separate from the conical body, and the width differs from the base, then an additional piece of the cone must be attached to the conical body in an extra fabrication step. In molds for glass, ceramic, and plastic coffee cones, it is a simple matter to form the drip ring with any width or shape, as a protrusion from the bottom of the ring collar, because the drip ring is part of a single mold. If metal material is used, a drip ring with a different width than the base of the cone makes the design overly complicated and difficult to fabricate. In a metal fabrication process, separate drip rings require separate secondary assembly onto the conical body. In most prior art, the drip ring is not the same width as the base of the cone. Prior art that disclose a drip ring with a different width includes foreign patent for paper filters, JP10286180 to Tanaka (1998) FIG. 6; and foreign patent LU48391 to Bentz (1965) FIG. 7. Tanaka discloses a drip ring that is wider than the base of the cone FIG. 6. Bentz discloses one drip ring that is wider and one that is narrower than the base of the cone FIG. 7. U.S. Pat. No. 224,397 to Bentz (1941) discloses one embodiment that does have a drip ring that is the same width as the conical body FIG. 8. However, that design has a second problem, which is a drip plate that extends too far below the ring collar.

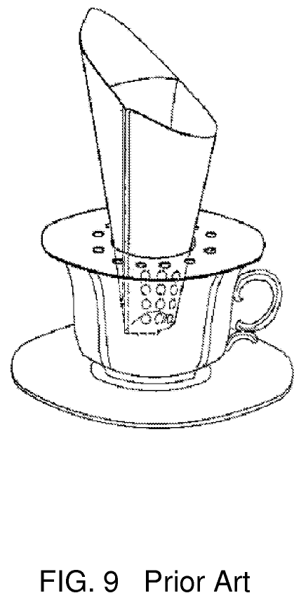

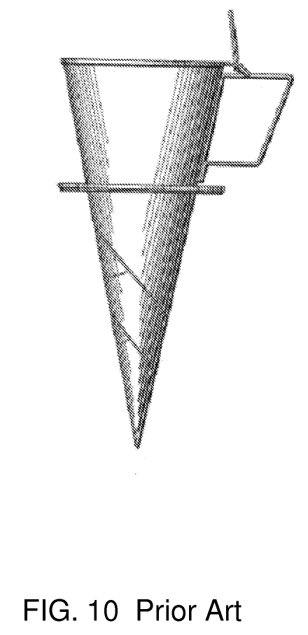

2) The drip plate should not extend far below the ring collar. A drip plate should not extend deep into the cup itself because with such extension, coffee filtration becomes submerged in the rising level of the coffee inside the cup and stops too soon before the cup is full. It is far more effective for drip filtration to occur above the height of the cup's rim. Foreign patent FRI 105494 to Wilh (1955) also discloses a drip plate located too far below the ring collar FIG. 9. Like Bentz (1941), Wilh discloses a cone that functions more like a tea infuser than a drip coffee filter. U.S. Pat. No. 975,874 to Korn and Kuhn (1910) discloses a cone that can be fabricated in metal material FIG. 10. However, the cone disclosed by Korn and Kuhn has the same drawback, that filtration occurs too far below the ring collar like tea infusion.

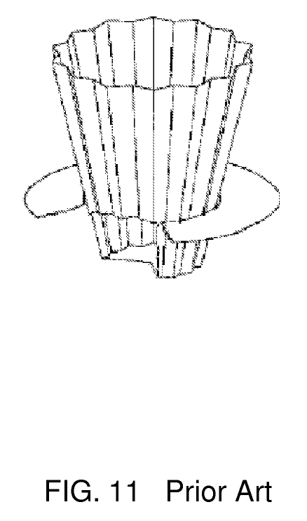

3) Another problem is that there should not be vertical ribs inside the conical body because ribs are not necessary for coffee percolation. Examples of prior art that disclose vertical ribbing inside the cone are Tanaka FIG. 6, and Bentz FIG. 7. Much of the prior art explains that ribbing on the interior wall of the cone is provided in order to facilitate filtration and flow of coffee downward. However, coffee will filter equally when the cone has a smooth surface inside the cone. To make vertical ribbing in a metal cone, the ribbing would have to be welded as individual ribs on the inside of the cone, or cut into the surface of an extra-deep sheet of metal in order to achieve grooves. Such groove cutting would be a costly process and would result in much wasted metal that is discarded. Adding ribs by welding each of them onto the surface would also be costly. U.S. Pat. No. 4,221,670 to Ziemek and Kabel (1980) discloses a variation of vertical ribbing in a metal cone that is a corrugated conical body FIG. 11. It is likely that the cone disclosed by Ziemek and Kabel has not achieved commercial success because the corrugated conical body may be unappealing to the public. Also it is more difficult than a smooth surface for the user to clean after each use. Also, Zimek and Kabel disclose a drip plate set too low below the ring collar that hinders filtration. While ribs disclosed by prior art may have added to consumer appeal, they can be omitted from the design because they complicate fabrication and are unnecessary.

In summary, design features of prior art are not compatible with metal construction. Separate and protruding components that are easily achieved by a glass, ceramic, or plastic mold are much more difficult to create using common metal fabrication processes such as spinning, deep drawing, or folding and welding. To fabricate a cone in metal, the minimum components necessary for coffee filtration must be identified to create the simplest and most cost-effective design possible. Also, minimization of welded joints will maximize the cone's overall strength. These simplifications are critical in order to use metal material for a cone.

Problems with Prior Art Materials:

While glass, ceramic, and plastic are used exclusively today for manual drip coffee cones, these materials have a number of drawbacks. Glass and ceramic cones are heavy and fragile. Their weight and fragility makes them break easily during regular use and adds to the costs of shipping. Plastic cones are scratchable, flammable, and retain odors.

An additional concern about plastic is that its raw material is a scarce resource-petroleum. There is a growing popular desire among consumers to reduce dependence on and use of petroleum products in order to conserve that resource. Ecologically minded members of the public want an alternative to plastic coffee cones that is lightweight and not easily breakable.

Additionally, in recent years, there has been increasing public concern about the use of plastics for preparing and eating foods and beverages. The concern is a perceived risk of chemical transfer and contamination into a food or beverage that is prepared in plastic cookware because plastic is not an inert material. Plasticizers such as phthalates are added to plastic to make it flexible for molding. A common perception is that when you heat plastic cookware, some amount of phthalates contaminates the food or beverage contained in it. In humans, phthalates mimic hormones and can act as endocrine disruptors which can cause bad health effects. No assertion is made here as to the validity of the concern about plastic cookware posing a health threat. However, the public perception of the possibility of chemicals leaching from plastic is enough to stimulate a consumer demand for a coffee cone that is made of an inert material such as stainless steel that has no risk of chemical transfer.

Plastic also has environmentally toxic manufacturing by-products. There is growing public concern about potential dangers of plastic to the environment. One of the most common materials for plastic cones is propylene (as molded polypropylene thermoplastic resin). An Internet web article states that:
“In an EPA ranking of the 20 chemicals whose production generates the most total hazardous waste, five of the top six are chemicals commonly used by the plastics industry”.
   The article further states that propylene is ranked first as the worst chemical whose production generated the most total hazardous waste. (www.ecologycenter.org: Connett, Ellen & Paul Connett; Waste Not #362 Summer 1996; Wrapped in Plastics: the environmental case for reducing plastics packaging, by Jeanne Wirka for the Environmental Action Foundation, 1988). The article states that toxic chemicals used in the production of propylene are methanol, 2,6-di-tert-butyl-4-methyl phenol, and nickel dibutyl dithiocarbamate. No assertion is made here as to the validity of the concerns over plastic's potential toxic effects to the environment. However, the public perception of plastic's possible environmental toxicity is enough to stimulate a consumer demand for a coffee cone that is made of material that contains no such toxics. Together with durability, these negative aspects of plastic material are two of the main reasons that stainless steel travel mugs and stainless steel travel water bottles have gained great popularity in recent years.
   Metal Material Previously Taught Away from in Prior Art:

No modern manual drip coffee cones are produced in metal. Melittta/Bentz produces their cones only in ceramic and plastic. Bodum Inc. and Chemex Inc. make similar cones in ceramic and glass material. The most recent of the Melitta/Bentz cone designs (foreign patent LU48391 to Bentz (1965)) specifically states in its claims that the preferred material for the cone is plastic (claim #9), or china earthenware (claim #12). There is much recent prior art for manual drip coffee cones that teaches away from the use of metal material.

U.S. patent D203854 to Douglas (1966) and U.S. Pat. No. 3,334,574 to Douglas (1967) disclose a preference for plastic to be the cone material as molded polypropylene, due to its ability to withstand stains and high temperatures. However, plastic cones often melt when accidents occur during their use if they are placed near an open flame or hot stove burner. U.S. Pat. No. 1,160,924 to Mangisch (1915) discloses the cone material to be “preferably formed of glass and reinforced by means of the metal bands”. U.S. Pat. No. 2,885,290 to Krasker (1959) states that the material used for making the device should be a “moldable thermoplastic or thermosetting resin or plastic that is heat insulating in nature”. U.S. Pat. No. 3,215,060 to Perlov (1964) discloses a cone material that is “hard shatterproof, tasteless molded plastic material having a low co-efficient of thermal expansion”. U.S. Pat. No. 3,695,168 to Van Brunt (1972) discloses a cone that is an “injection-moldable synthetic polymer composition material.” And further, that “Polyethylene and polypropylene are preferred materials, because of their convenient molding characteristics.” U.S. Pat. No. 4,167,136 to Chupurdy discloses a cone that is “fabricated from a synthetic resinous material such as polypropylene, nylon, or the like”. U.S. Pat. No. 2,358,556, to Block (1994) discloses the express use “of glass, ceramic or similar material of poor heat conductivity”.

While prior art includes cone designs that have been commercially successful, there is opportunity to improve the various concepts into one simplified design that can be more easily fabricated in a superior material that is metal such as stainless steel.

### SUMMARY

In accordance with one embodiment, the improved design of a manual drip coffee cone comprises a truncated conical body whose base forms a drip ring; a drip plate with a drip hole is set inside the conical body a short height above the bottom of the cone; a ring collar that radiates out from the conical body at a short height above the bottom of the cone; a conical body that has no interior vertical ribbing; and a material for the cone that is one of various metals.

### DRAWINGS

### Figures

### First and Additional Embodiments

In the drawings, different views of one embodiment share the same number, differentiated by alphabetic suffixes.

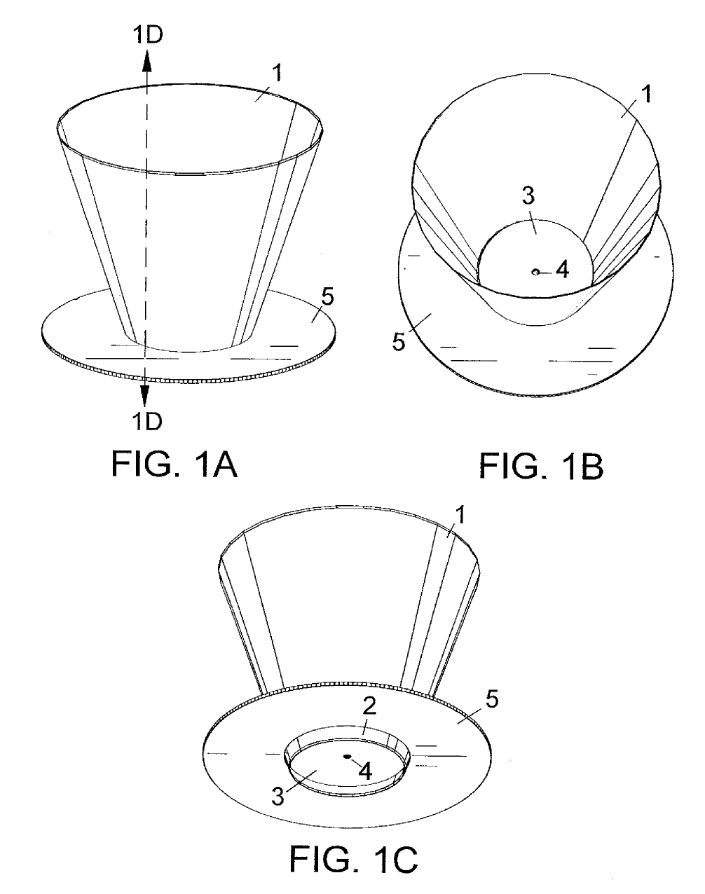

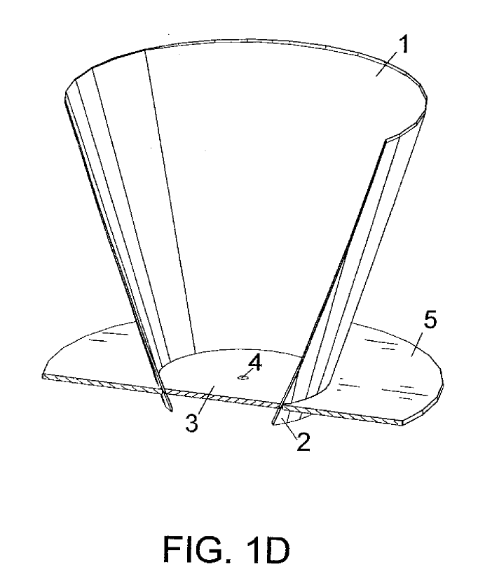

FIGS. 1A, 1B, 1C, and 1D show Embodiment #1—a cone that has a conical body with a round-shaped base that forms a drip ring, a round drip plate with a drip hole in it, a ring collar that is a solid plane with a round inner edge, and that has single wall construction.

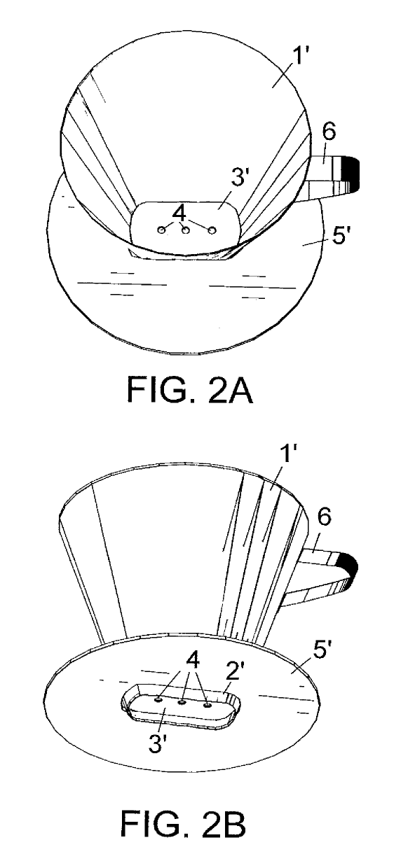

FIGS. 2A, and 2B show Embodiment #2—a cone that is the same as the first embodiment but instead has a conical body with an elliptical-shaped base, an elliptical drip plate with three drip holes in it, a ring collar that is a solid plane with an elliptical inner edge, and a tea cup style handle.

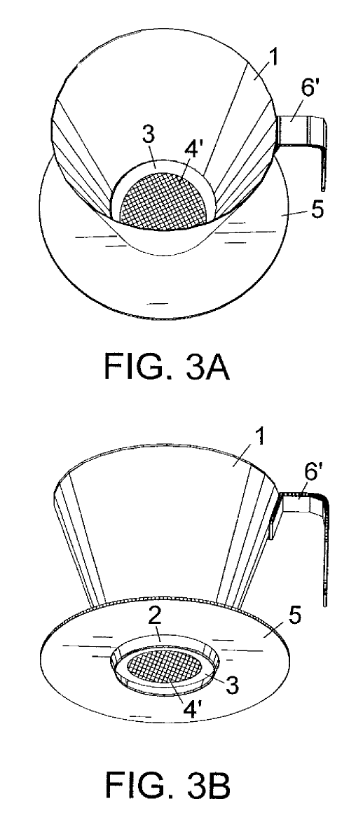

FIGS. 3A, and 3B show Embodiment #3—a cone that is the same as the first embodiment but instead has a drip plate that has a large drip hole with a mesh screen, and a measuring cup style handle.

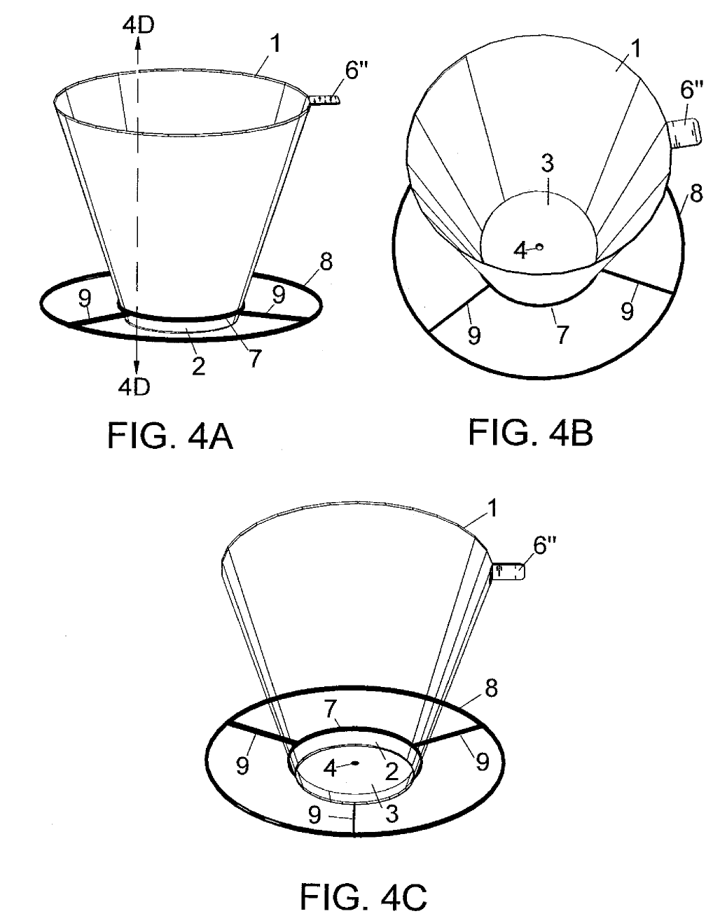

FIGS. 4A, 4B, and 4C show Embodiment #4—a cone that is the same as the first embodiment but instead has a ring collar that is a see-through frame, and a tab style handle.

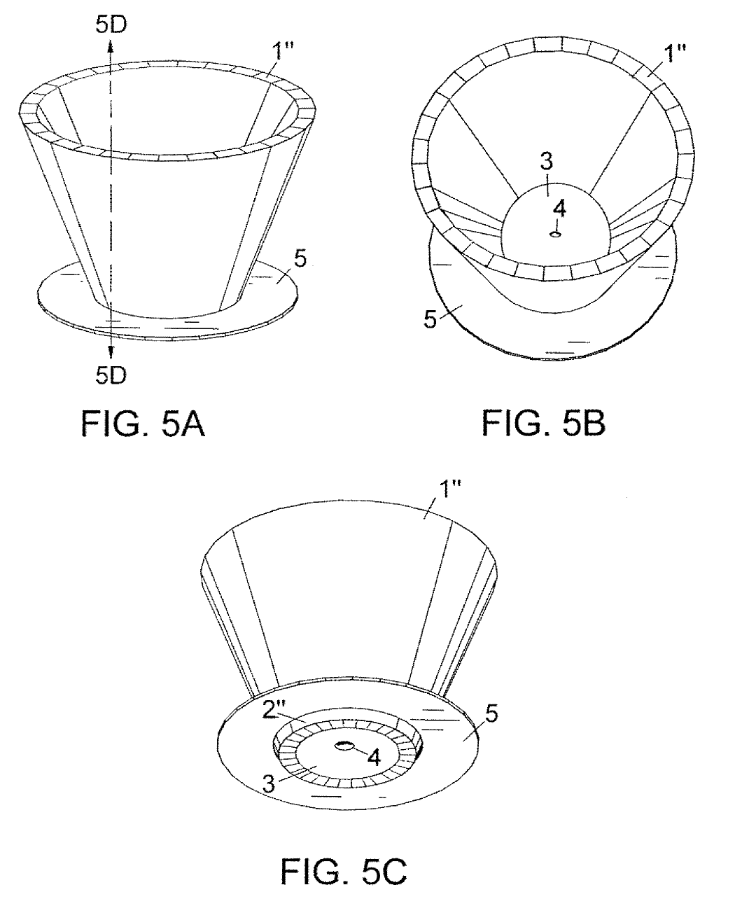

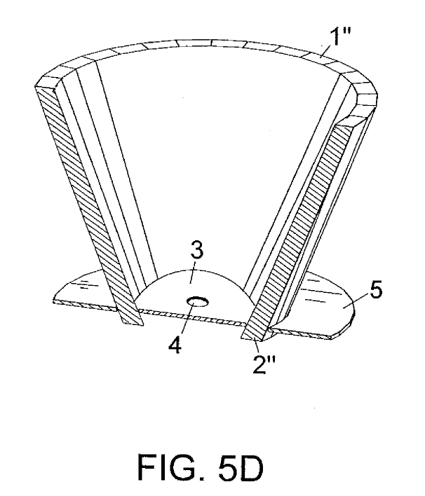

FIGS. 5A, 5B, 5C, and 5D show Embodiment #5—a cone that is the same as the first embodiment but instead has a conical body with double wall construction and a corresponding drip ring with double wall construction.

### Prior Art

FIG. 6 Foreign patent JP10286180 to Tanaka (1998).

FIG. 7 Foreign patent LU48391 to Bentz (1965) [also published as BE662750 to Melitta-Werke, Bentz & Sohn (1965); NL6504902 to Bentz (1965); GB1103912 to Bentz (1968); CH458663 to Bentz (1968); NO117998B to Bentz (1969); and F142462B (B) to Bentz (1970).]

FIG. 8 U.S. Pat. No. 224,397 to Bentz (1941) [also published as foreign patent GB494312 to Melitta-Werke, Bentz & Sohn (1938)].

FIG. 9 Foreign patent FRI 105494 to Wilh (1955).

FIG. 10 U.S. Pat. No. 975,874 to Korn and Kuhn (1910).

FIG. 11 U.S. Pat. No. 4,221,670 to Ziemek and Kabel (1980).

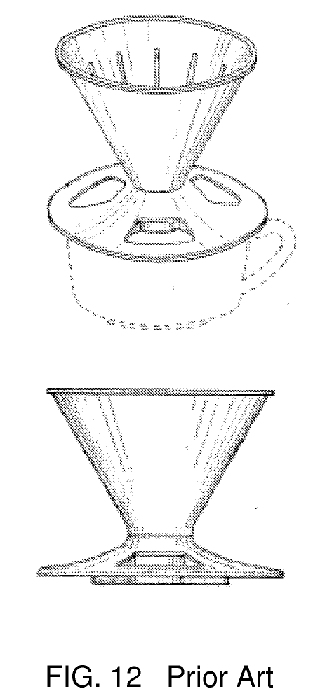

FIG. 12 U.S. Pat. No. 203,854 to Douglas (1966).

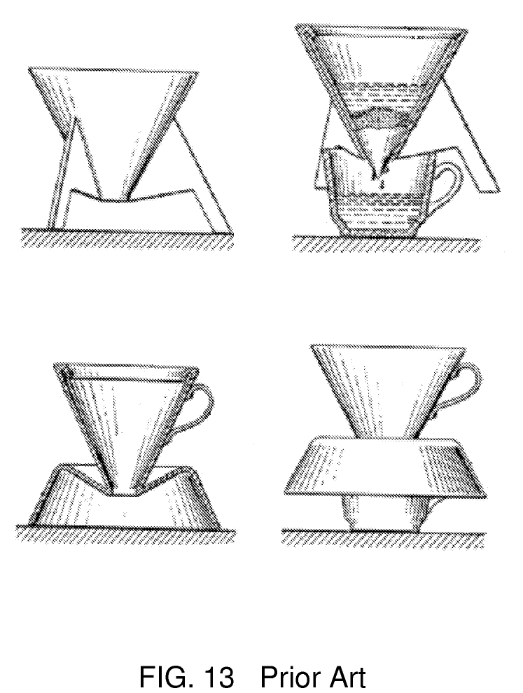

FIG. 13 U.S. Pat. No. 2,835,191 to Clurman (1958).

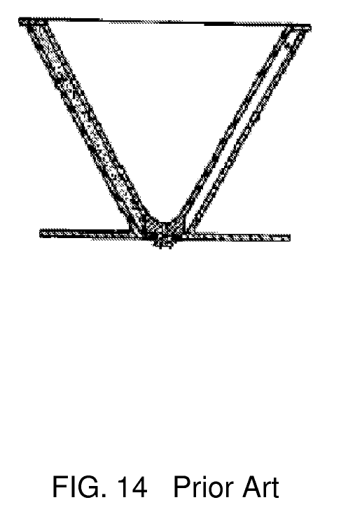

FIG. 14 Foreign patent DE2607605 to Schnause (1977).

### REFERENCE NUMERALS

### FIGS. 1A to 5D

1 conical body with a round base
1′ conical body with an elliptical base
1″ conical body with double wall construction
2 drip ring with a round shape
2′ drip ring with an elliptical shape
2″ drip ring with double wall construction
3 drip plate with a round shape
3′ drip plate with an elliptical shape
4 drip hole
4′ drip hole with a mesh screen
5 ring collar with a round inner edge
5′ ring collar with an elliptical inner edge
6 handle—tea cup style
6′ handle—measuring cup style
6″ Handle—tab style
7 ring collar frame—inner ring
8 ring collar frame—outer ring
9 ring collar frame—radial spine

### FIGS. 6 to 14

The reference numerals shown on the drawings of prior art do not apply to the discussion. Original reference numerals from the prior art are only reproduced as part of the drawings from the original image; they are not discussed or referred to anywhere within the text of this application.

### DETAILED DESCRIPTION

### Embodiment #1

### FIGS. 1A, 1B, 1C, and 1D (Cone with a Round-Shaped Base)

The first embodiment of the invention is shown in a front perspective view of the cone FIG. 1A, a top perspective view FIG. 1B, a bottom perspective view FIG. 1C, and a cross sectional view FIG. 1D. In Embodiment #1 a conical body with a round base 1 is truncated at the bottom. The base of the conical body 1 forms a drip ring with a round shape 2. The first function of the drip ring 2 is to direct drips downwards. The second function of the drip ring 2 is to prevent the cone from slipping off the cup or carafe on which it sits. Inside the conical body 1 is a drip plate with a round shape 3. The cross sectional view of Embodiment #1 shows that the drip plate 3 is set inside the conical body 1 a short height above the bottom of the drip ring 2, FIG. 1D. The drip plate 3 has one drip hole 4. A ring collar with a round inner edge 5 radiates out from just above the base of the conical body 1 at the same height as the drip plate 3. The ring collar 5 allows the cone to sit on a cup or carafe. The cone is simple to construct because it has only three main components—a conical body 1, a drip plate 3, and a ring collar 5. The drip ring 2 is the bottom portion of the conical body 1.

The main innovation shown in the embodiments of this invention is the placement of the drip plate 3. When a drip plate 3 is placed inside a conical body 1 a short height above the base, it allows the base of the conical body 1 to become a drip ring 2. This design allows the conical body 1 to satisfy two functions. The top part of the conical body 1 holds coffee grounds for filtration, while the bottom part of the conical body 1 is the drip ring 2. This innovation allows the cone to be easily fabricated in metal material because the same sheet of metal forms two components at once. Secondly, the drip plate 3 is set at the same height as the ring collar 5 that sits on the cup or carafe, and thus allows drip filtration to occur at the same height as the rim of the cup beneath. This allows maximum head space above the cup's rim for coffee to drip into the cup below.

The material of the conical body 1, drip plate 3, and ring collar 5 is metal that is currently preferred to be, but is not limited to, one from the set of the following:
a) Stainless steel is one of the primary materials envisioned for the cone. The stainless steel could have either a shiny chrome finish or brushed steel appearance. The finish may also be colorized.
b) Enamel-coated metals are also planned for the cone. The enamel-coated metal would include, but not be limited to, steel, tin, aluminum, iron, or other metal. The design of such enamel coating would vary, but may commonly be produced as a solid color or with white speckles such as is often done to reproduce vintage and antique enamelware.
c) Titanium is also envisioned for the cone due to its superior strength, lightweight, and common use for outdoor camping cookware.
d) Anodized metals are also well suited to the cone.

### Embodiment #2

### FIGS. 2A, and 2B (Cone with an Elliptical-Shaped Base)

A second embodiment of the invention is illustrated in a top perspective view of the cone FIG. 2A, and a bottom perspective view FIG. 2B. Embodiment #2 has a conical body with an elliptical base 1′. It has a drip ring with an elliptical shape 2′ and a drip plate with an elliptical shape 3′. The drip plate 3′ has three drip holes 4. It has a ring collar with an elliptical inner edge 5′ in order to fit around the elliptical shaped base of the conical body 1′. A tea cup-style handle 6 is attached at the side of the conical body 1′.

This embodiment provides a shape for the base of the cone that is a modified ellipse, like a rectangle with rounded edges. The elliptical shape of the base of the cone is more similar to the most popular cones sold today by Melitta/Bentz and standard paper filters, and so may have wider consumer appeal than the round shape of the base of the cone in Embodiment #1. However, the round shape of the base of the first embodiment, and the elliptical shape of the second embodiment function equally well with the same standard paper filters that have a straight-shaped bottom.

### Embodiment #3

### FIGS. 3A, and 3B (Cone with a Drip Hole with a Mesh Screen)

A third embodiment of the invention is illustrated in a top perspective view of the cone FIG. 3A, and a bottom perspective view FIG. 3B. Embodiment #3 is the same as Embodiment #1, but instead has a larger round drip hole with a fine mesh screen 4′. The drip hole with a mesh screen 4′ has a screen made of fine wire, such as stainless steel, gold, or similar material. The drip hole with a mesh screen 4′ allows the user to put coffee grounds in the cone directly, without using a filter paper or other filter. Embodiment #3 has a measuring cup-style handle 6′ attached to the side of the cone.

Embodiment #3 can just as easily be used with a filter if the user desires to do so. Some users may prefer this embodiment but usually use it with a paper filter, for ease of clean-up. They may want to have the filter-free option available to them for times that filters are not available in their house or during travel or back-packing trips.

### Embodiment #4

### FIGS. 4A, 4B, and 4C (Cone with a See-Through Ring Collar)

A fourth embodiment of the invention is illustrated in a front perspective view of the cone FIG. 4A, a top perspective view FIG. 4B, and a bottom perspective view FIG. 4C. Embodiment #4 is the same as Embodiment #1, except that it has a ring collar that is a ‘see-through’ frame comprised of an inner ring 7, an outer ring 8, and three radial spines 9. The three radial spines 9 connect the inner ring 7 to the outer ring 8 like the spokes of a wheel. This embodiment of the ring collar allows the user a view beneath the cone in order to see the rising level of the coffee in the cup or carafe below. The ‘see-through’ ring collar frame, consisting of three parts 7, 8, and 9 is constructed of tubular wire or similar. Embodiment #4 has a handle that is a tab 6″ attached to the top lip of the cone.

A few prior art cone designs have disclosed variations on window openings in the ring collar, but none have achieved a simple and efficient enough design that can be easily reproduced in metal material. Adding window openings into the ring collar is disclosed by Douglas FIG. 12, and in U.S. Pat. No. 3,334,574 to Douglas (1967). The same idea was disclosed in U.S. Pat. No. 3,695,168 to Van Brunt (1972). However, both Douglas and Van Brunt disclose an overly complicated ring collar with a flared/ramped shape instead of a simpler flat shape. The flared/ramp shape of the Douglas and Van Brunt ring collars can be easily fabricated in a plastic mold, but would be much more difficult to make with sheet metal. U.S. Pat. No. 2,835,191 to Clurman (1958) discloses a ring collar that may allow a view beneath the cone FIG. 13. However, like Douglas and Van Brunt, the complicated shape of Clurman's ring collar would be difficult and expensive to fabricate in metal, compared to a flat-shaped ring collar.

Wilh discloses a variation of holes cut into the ring collar FIG. 9. Holes disclosed by Wilh are meant to allow a hydraulic release of pressure from the cup below through the ring collar to make coffee filtration flow more quickly. Since the perforations disclosed by Wilh are meant to allow steam vapor to exit the cup, and are small in diameter, they do not allow the user to see beneath the cone to the coffee below. Further, Wilh discloses a conical body that protrudes so far below its ring collar that it becomes submerged in the cup in a manner that more closely resembles the process of tea infusion than coffee filtration.

Openings in the ring collar disclosed to date do not offer a clear enough view to the coffee level beneath the cone. Window openings previously disclosed by prior art only allowed a partial view that is obstructed because a large part of the ring collar remains and blocks the view to the coffee below. This forces the user to adjust one's head to various angles in order to try to see through the relatively small window openings. The prior art's window openings have not achieved a view below the cone as well as that can be provided if the ring collar is simply a flat ‘see-through’ frame.

### Embodiment #5

### FIGS. 5A, 5B, 5C, and 5D (Cone with Double-Wall Construction)

A fifth embodiment of the invention is shown in a front perspective view of the cone FIG. 5A, a top perspective view FIG. 5B, a bottom perspective view FIG. 5C, and a cross sectional view FIG. 5D. Embodiment #5 is the same as Embodiment #1, except that it has a conical body with double wall construction 1″ in order to provide thermal insulation. The double-walled conical body 1″ is comprised of both an inner and outer wall. The double walls are joined together across at their top and bottom. Air space provides thermal insulation between the two walls. The double-walled conical body 1″ has a drip ring with double wall construction 2″ because it is the lower portion of the double-walled conical body 1″.

In Embodiment #5, insulation between the double walls may be air, vacuum insulation, or other similar methods of insulation. Vacuum-insulated double-walled construction has become popular in the manufacture of travel mugs and work thermoses. An example of double-walled construction is found in thermoses and travel mugs made by the Thermos Inc. Company, which uses a vacuum-insulated, double-walled stainless steel named TherMax™.

Embodiment #5 has better insulating capability than the four previous single-walled embodiments. However, it is expected that the double-walled version would cost more than single-walled cones. Therefore, it is preferable to produce both single and double-walled versions, so that consumers who can't afford a double-walled one, can still choose a similar model that is metal. In this way, multiple versions of a metal cone can be made available to a wider spectrum of the public.

Of the prior art, only foreign patent DE2607605 to Schnause (1977) discloses an insulated conical body FIG. 14. However, the type of insulation disclosed by Schnause is too narrowly limited to allow the more modern innovation in insulation that uses air or vacuum insulation between double metal walls. Schnause discloses a cone that has insulation restricted to foam. In four of his official Claims, Schnause claims only foam to be the insulator, as follows:
“4) Filter housing after 1) to 3), thereby characterized, that that warm-damming material from a foam material molded article exists.
5) Filter housing after 1) to 4), by the fact characterized that that Foam material molded article from PURE, PP, PE, PVC, PMM exists.
6) Filter housing after 1) to 5), by the fact characterized that the foam material molded article consists of a flexible material.
(7) Filter housing after 1), by the fact characterized that it consists of an integral foam material.
8) Filter housing after 1) to 7), by the fact characterized that it consists of polyurethane integral foam.”

Schnause's claims do not include newer, more technologically advanced methods of material insulation such as vacuum insulation. Another problem with the Schnause design is that the drip ring is narrower than the base of the cone and is a separate protrusion attached to the bottom of the ring collar, thus complicating its fabrication with metal material.

### OPERATION

### All Embodiments—FIGS. 1A to 5D

To use the coffee cone, the cone is placed on top of a cup or carafe by setting the ring collar 5 or 5′, or ring collar frame radial spines 9 on the rim of a cup or carafe. Next, a filter is placed into the conical body 1, 1′, or 1″. Paper filters are typically used. Other coffee filters could also be used with the cone such as those styled as a cotton sock, or a ‘permanent filter’ whose cone-shaped mesh screen is typically composed of gold. Next, coffee grounds are put into the filter. For Embodiment #3, the filter is optional and coffee grounds can be added directly into the cone that has a drip hole with a mesh screen 4′. Embodiment #3 can be used with or without a filter. Next, nearly boiling water that was heated in a separate teakettle, or similar source, is poured over the grounds. Water is typically poured in stages. First, water is poured over the grounds to wet and expand them. Then, more hot water is poured over the grounds to drip through the cone into the vessel below. Coffee drips through the drip hole 4 or drip hole with a mesh screen 4′ that is located in the center of the drip plate 3 or 3′. Coffee drips past the drip ring 2, 2′, or 2″ into the cup or carafe beneath the cone. The process is complete when the vessel below is full of coffee. Then the cone can be cleaned or set aside to re-use for multiple cups of coffee. Models without a handle 6, 6′ or tab 6″, are lifted by the conical body 1, 1′ or 1″ itself.

### ADVANTAGES

From the description above, a number of advantages of the embodiments of the invention are evident:

### (a) Improved Design Solves a Previously Insoluble Problem and Succeeds Over Previous Failure of Others

The design simplifies components of prior art into the basic minimum requirements for a manual drip coffee cone. This creates a design that can be easily fabricated in metal material without a molding process. The three simplifications are:
The drip ring is the bottom of the conical body: This feature allows the conical body to form two components that serve two different functions. This simplification makes manufacturing the cone most efficient and economical for working with metal material.
The drip plate is set inside the cone at or near the same height as the ring collar. This creates the ability for the base of the conical body to become the drip ring. It also maximizes the amount of room for coffee to drip into the cup below.
Interior ribbing not needed: Coffee filtration occurs efficiently without vertical ribbing along the interior walls of the cone. Omitting the ribbing saves material costs and fabrication effort for metal materials.

### (b) Metal Material Succeeds Over Previous Failure of Others

The improved material succeeds where previous cone materials of glass, ceramic, and plastic fail. Metal cones have a unique combination of three advantages.
Unique combination of advantages: Metal alone does what glass, ceramic, and plastic cannot do by themselves. Metal has the advantage of plastic, by being light weight and durable, combined with the advantage of glass of ceramic, by having an inert surface chemistry that resists odors, scratching and flammability. Metal material alone incorporates into one product the advantages of all three of the other popular materials. Metal is lighter weight than ceramic or glass and therefore is easier to use, lift, and handle. Glass and ceramic cones often break and have to be replaced frequently especially when they fall onto kitchen counters or floors made of tile. The durability of metal material makes them less brittle than plastic and less breakable than glass or ceramic. This durability makes metal cones a better long-term economic investment for the consumer. Additionally, glass and ceramic cones are fragile to ship and so are commonly shipped with a small individual cardboard box around each one. This need for extra cushioning makes the overall production costs more expensive. The extra packaging also makes them less environmentally friendly. It is envisioned that the metal cones would be sold without any packaging at all, with a price tag affixed directly to the cone.

### (c) Metal Material Provides a Previously Unappreciated Advantage

Metal materials provide three particular advantages over plastic cones that until now were previously unappreciated:
Perceived benefit for human health: The inert nature of metal materials makes them more desirable than plastic for preparing hot beverages based on commonly perceived health concerns about toxic chemicals in plastic. Metals, such as stainless steel and titanium, have a more inert surface chemistry and so do not impart their own chemicals into hot water that is poured through the cone. In this way, metal materials are perceived to result in a more chemical-free coffee.
Benefit for the environment: Compared to plastic, metal's raw material produces less toxic waste products from the cone's manufacture and production.
Reduces dependence on global oil supplies: Metal's raw material is not petroleum, as is plastic's, and so does not cut into the already strained availability of worldwide oil supplies. This satisfies a growing popular desire among consumers to reduce dependence on and use of petroleum products in order to conserve that resource. A metal cone with a modern design will offer a great alternative to eco-conscious consumers.

### (d) Metal Material Solves Prior Inoperability

Metal material solves three aspects of operation compared to plastic cones:
Inflammable: Unlike plastic, metal cones will not melt when placed near an open flame, or hot stove burner.
Better taste: The inert nature of the metal materials makes them less likely to retain food odors. Plastic cookware retains food odors more readily than metal cookware. Stainless steel materials are used in commercial kitchens in order to avoid this problem. Metal's ability to withstand food odors is the advantage often cited in advertisements for other stainless steel kitchen tools such as graters, funnels, mixing bowls, and a myriad of other kitchen tools and gadgets. Even after cleaning them, plastic cones often retain a rancid coffee taste, and the smell of old coffee remains on the cone even after it has been washed in warm soapy water.
Less scratchable: A plastic cone scratches over time with repeated use resulting in surface abrasions. This gives the plastic cone an overall aged appearance and exacerbates the problems of odor retention and leaching of the cone's plastic taste into the hot water that is poured through it.

### (e) Metal Material Solves a Long-Felt Need

The innovation of metal material solves a need for coffee cones that its glass, ceramic, and plastic counterparts fail. The need stems from two market areas:
The General Public: Metal cones answer a demand for lightweight and durable cookware. Manual drip coffee cones are one of the few kitchen tools today that are not available in any metal. The reason is that until now, a modern design has not been developed that can accommodate fabrication in metal material in an appealing design that is efficient cost effective. Metals including stainless steel, and enamel-coated and anodized aluminum and steel, have proven themselves to be popular materials for contemporary cookware and for a wide array of coffee making tools and accessories. Metal offers a greater array of aesthetic choices than is currently available to the consumer public for manual drip coffee cones. Both stainless steel and vintage enamel-coated metal cookware are known to have wide consumer appeal. Currently popular in many modern kitchens is the use of stainless steel appliances such as stainless steel refrigerators, ovens, stoves, dishwashers, and microwave ovens. When displayed in such a kitchen, the coffee cone made of plastic or ceramic does not offer a matching kitchen tool. Consumers want their kitchen tools to match other kitchenware items that are gaining tremendous popularity in today's marketplace such as stainless steel blenders, toasters, and other various stainless steel utensils. A different consumer group enjoys the antique look of old fashioned kitchens and desires the aesthetic of cooking tools made with enamel-coated metals. Such kitchens often display vintage country or camping cookware that is enamelware, which is usually red or blue, colored with white-speckles. There is an established demand for kitchen tools made of the wide array of metal materials. And for consumers who prefer to make coffee with a metal apparatus, such as a stainless steel French press, or an enamelware percolator, the metal manual drip coffee cone is an appealing less expensive option. Making metal coffee cones would provide this consumer market with an exciting new product.
The travel and outdoor sporting community: Outdoor recreation sports such as camping, backpacking, climbing, cycling, and boating, place additional importance on the need for lightweight, durable cookware. These sports enthusiasts desire cookware that weighs as little as possible and is as strong as possible, because the cookware items will be carried in a boat, bike pannier, or backpack. The most popular cookware materials for these sports are stainless steel, anodized steel, and titanium. The relatively high price for these goods made of steel, and titanium is met by this outdoor-recreation community with great demand and enthusiasm.

### (f) Improved Design Succeeds Over Previous Failure of Others

### Additional Embodiments

Additional embodiments of the design succeed where prior art has failed. Two advantages are evident:
A frame style ring collar is ‘see-through’: A ring collar that is a ‘see-through’ frame allows the user to see the coffee level in the cup or carafe beneath the cone. Without the ability to see the rising level of coffee, the user has to lift the cone off the cup repeatedly during the dripping process in order to see when the cup level is almost full. This leads to frequent occurrences of the coffee overfilling its vessel and spilling over because the user cannot easily see when to stop pouring water into the cone. Prior art has disclosed window holes cut into the ring collar that are difficult to look through because the ring collar is not flat and the window openings are too narrow to easily see through. Embodiment #4 of the invention allows the user a clear view to the rising level of coffee beneath the cone because the ring collar is constructed only as a frame. With the ring collar forming a simple frame, the user does not have to adjust or move the cone to different angles to see into the cup because no angle is obstructed. Minimum material makes up the ring collar and reduces the cone's overall weight. This reduces weight for shipping and for transport and handling by the user. Since the ring collar is flat and not a flared shape, its fabrication does not require an overly complicated metal fabrication operation.
A double-walled conical body gives insulation: Embodiment #5 of the invention is constructed with a double wall in order to accommodate air or vacuum insulation. Most prior art discloses cones that are not well insulated. Insulation keeps hot water warmer as it drips through the cone, thus reducing cooling of the coffee. Insulation also affords a user protection from an overly hot cone surface while the person handles the cone during coffee making. Using double-walled construction with air or vacuum insulation is an innovation that has not been disclosed by prior art.

### CONCLUSION

The embodiments of the invention modify the prior art and improve it. The improvements focus on simplifying construction of the conical body so that it can be easily manufactured in metal material. Simplifications include: a conical body whose base forms a drip ring; a drip plate that is set at a height above the rim of the receiving cup or carafe in order to maximize room for drip filtration; and omission of interior ribbing. An additional embodiment of the invention modifies the base of conical body to be elliptical instead of round-shaped. Another embodiment of the cone has a larger drip hole with a fine mesh screen. This allows grounds to be added directly to the cone without using a paper or other filter. Another embodiment modifies the ring collar by constructing it as a ‘see-through’ frame. This maximizes the ability to see the coffee level in the cup or carafe. Another embodiment of the cone has double walled insulation. This reduces heat loss of coffee percolating through the cone, and makes the cone easier to handle for the user.

Much of the modern prior art for manual drip coffee cones teaches away from metal material. However, metal material gives a wide array of unobvious and unexpected results and benefits for the coffee cone. When metal is used with a modern design for a cone, then it is superior to its glass, ceramic, and plastic counterparts. This is because the overall appearance and function of the cone is the same as the molded versions, but it has a material that combines the advantages of all three other competing materials. Accordingly, it is evident that the embodiments of the invention are superior to and improve prior art by omitting unnecessary parts, simplifying the design, and using a material with far superior properties than what is used in today's modern manual drip coffee cones.

### RAMIFICATIONS

1. Different sizes and volumes: The conical body may have any possible variation of volume or height. The conical body may be constructed in various sizes such as to fit #2, #4, #6 and other various size filters in order to fit onto various cups as well as carafes, pots, and other serving vessels.
2. Variable diameters for the ring collar or ring collar frame: The ring collar, or ring collar frame may have any variable radius or diameter whereby various models will sit on a wide range of rim sizes of the cup, carafe, pot, or other serving vessel below it.
3. Different shapes for the base of the conical body: The base of the conical body may have any possible variation of shape. Instead of round or elliptical, the base of the conical body may be another shape such as a modified ellipse, a rectangle with rounded edges, or any other similar shape. Accordingly, the drip ring would have the same modified shape because it is the base of the conical body. And accordingly, the drip plate would also take the same modified shape in order to fit inside the cone near its base. The inside edge of the ring collar, or the inner ring of the ring collar frame would also have the same modified shape in order to fit snugly against the base of the conical body.
4. Optional grip coating: A coating of rubber, silicone, or material of similar insulating nature may be added to the conical body, ring collar, ring collar frame, or handle. The grip material that is rubber, silicone, or similar material has two functions. First, it acts as a grip to prevent slipping. Secondly, it insulates against the relatively warm temperature of the heat-conducting material of the cone. Therefore, any portion or component of the cone may have a grip material affixed to it, whereby the grip provides the user a non-slip surface as well as protective insulation from the material beneath it.
5. Optional thermal jacket: A coating of plastic, silicone, rubber or similar material may be added to the conical body as a jacket. The jacket's function is to protect the user from the cone's heat and to act as an insulating layer to keep the water warm inside the conical body.
6. Modifications of the handle: The handle of additional embodiments may take any shape or form other than a tea-cup style, measuring cup style, or tab style handle. For instance, the handle could be modified to have a reduced width or overall size in order to reduce the unit's weight. Additionally, the handle could be constructed as a single or double loop made of tubular metal wire. The option of the first embodiment to have no handle at all might apply to the ‘traveler’ or ‘outdoorsman’ models of the cone. Omitting the handle in favor of tab, or omitting it altogether, trades the convenience of a handle for a greater savings in weight. It also makes it possible to pack the cone more tightly against other objects in a suitcase or back pack. The location of the handle or tab could vary and include locations such as, but not limited to, the side of the cone, the top rim of the cone, or on the ring collar or ring collar frame.
7. Drip plate: Inside the conical body, the drip plate may have various methods of installation. One embodiment may have a drip plate permanently set in position inside the conical body. Another embodiment may have the drip plate set inside in a way that allows removal for cleaning. Therefore the drip plate may have any variation of a tab, collar, or other feature to affix it into the cone permanently, or to allow it to be lifted in and out as a removable part.
8. Drip holes: The number and arrangement of the drip holes in the drip plate may be modified. For conical bodies with a round shape, it may be desirable to have multiple drip holes, such as three or more aligned in a triangular fashion. For conical bodies with an elliptical or rectangular shape, it may be desirable to have multiple drip holes, such as three or more aligned in a linear fashion. It may be desirable to have drip holes exist as semi circles placed along the outer edge of the drip plate so that drips are directed to pass against the inside edge of the conical body and drip ring. Drip holes may be arranged in any number of various patterns or configurations. Drip holes may also have any variation of a mesh screen, or screen modification. Therefore, the drip plate may have a varying number, alignment, or arrangement of drip holes, mesh screens, or similar, whereby filtration of coffee is made most effective.
9. Window openings in the ring collar: The ring collar may have any frame-like design that has various modifications to the shape, size, or number of the window openings cut into it, or spokes in the frame. Window openings may be of any varying size, shape, or number cut into the ring collar, whereby a person can view the rising coffee level in the vessel below the cone. If overall strength of the cone would not be compromised, one modification could be to omit the inner ring of the ring collar frame and weld or otherwise affix the radial spines directly to the conical body.
10. Cone interior: The inside of the conical body could be modified from a smooth surface. The design of the inside of the cone could be modified to add scoring or similar texture to the metal surface in order to facilitate filtration. Therefore, the conical body may have variable interior features or designs that may or may not include scoring, texturing or any variation thereof
11. Materials: Likely ramifications of the invention can be derived from other materials that are commonly used today in the cookware industry. One ramification includes the use of anodized steel or aluminum for the material. Another ramification includes the use of un-coated or enamel-coated cast iron. Other metals or materials in the future may be deemed appropriate and desirable for cookware and so would also be desirable materials for this coffee cone.
12. Decoration: Another ramification of the invention is any decorative design that could be embossed in the outer surface of the conical body, or affixed to it, or achieved with different combinations of coloration. Therefore, the cone may have any decorative design that could be embossed in it or affixed to it, or achieved with various combinations of coloration, or no such coloration or decoration at all.

### SCOPE

Although the description above contains many specifics about design and material, these should not be construed as limiting the scope of the embodiments, but merely providing illustrations of some of the presently preferred embodiments. Additionally, the modifications discussed in the various embodiments of the invention can be combined in multiple permutations. The diagram drawings are meant to show each feature individually that can be modified. The drawings do not show the extent to which various permutations can be created by mixing together the modifications in various multiple ways. For example, following are combinations of additional embodiments of the invention that are not shown in the drawings, but are meant to be implied in the specifications. 1) Embodiment #3 could be changed to have its drip hole with a mesh screen, combined with an elliptical shaped base instead of a round one; 2) Embodiment #3 could be changed to have its drip hole with a mesh screen, combined with a double-walled conical body; further that combination could have either a round or an elliptical shaped base; 3) Embodiment #4 could be changed to have its ‘see-through’ ring collar frame, combined with an elliptical shaped base instead of a round one; 4) Embodiment #5 could be changed to have its double-walled construction, combined with an elliptical shaped base instead of a round one; further, that combination could have either a solid ring collar or a ring collar that is a ‘see-through’ frame.

Thus, the scope of the embodiments should be determined by the appended claims and their legal equivalents, rather than by the examples or diagrams given.

I claim:

1) In a manual drip coffee cone of the type comprising a truncated conical body and a ring collar, the improvement wherein said cone has a conical body whose base forms a drip ring which simplifies the cone's design, and a drip plate is set inside the conical body a short height above its base whereby the conical body is divided so that its lower portion forms a drip ring, and a ring collar radiates out from the conical body at a short height above the base of the conical body thereby affording maximum space for coffee to drip into the receiving vessel below it, and the conical body does not have interior vertical ribbing and the ring collar has a flat shape instead of flared or ramped shape whereby fabrication with metal material is facilitated, and the material for the cone is constructed of a metal comprising one from the set that is, but not limited to, stainless steel, aluminum, cast iron, titanium, an enamel-coated metal, an anodized metal, or other metal or variation of metal-coated materials;

2) The conical body in claim 1 wherein said conical body has a base that has a modified elliptical shape, or any other various shape instead of round;

3) The cone in claim 1 further including a handle, tab, loop, or any handle variation affixed to it which facilitates lifting the cone;

4) The drip plate in claim 1 wherein said drip plate has a large drip hole with a fine mesh screen, whereby coffee grounds can be put in the cone without using a paper or other filter;

5) The ring collar in claim 1 wherein said ring collar is constructed as a ‘see-through’ frame, whereby a person can easily view the rising coffee level in the vessel below the cone;

6) The conical body in claim 1 further including double-wall construction that may have air, vacuum-insulation or other method of insulation between the double walls, whereby the conical body is made more insulating for retaining heat of the coffee water, and more heat-insulating protection is afforded to the user's hand.
